(19) United States
(12) Patent Application Publication
(10) Pub. No.: US 2017/0352095 A1
(43) Pub. Date: Dec. 7, 2017

(54) PORTFOLIO OPTIMIZED OFFERS FOR MOBILE DEVICE

(71) Applicants: Penny Jurss, Pewaukee, WI (US); Margaret Vasquez, Leesburg, VA (US); George Perry, Oakland, CA (US); Margaret Szeto, Mountain View, CA (US); Jaesung Park, San Francisco, CA (US); Kellen Mannion, San Francisco, CA (US)

(72) Inventors: Penny Jurss, Pewaukee, WI (US); Margaret Vasquez, Leesburg, VA (US); George Perry, Oakland, CA (US); Margaret Szeto, Mountain View, CA (US); Jaesung Park, San Francisco, CA (US); Kellen Mannion, San Francisco, CA (US)

(21) Appl. No.: 15/613,568

(22) Filed: Jun. 5, 2017

Related U.S. Application Data
(60) Provisional application No. 62/345,382, filed on Jun. 3, 2016.

(51) Int. Cl. G06Q 40/02; H04L 29/06; G06Q 30/02

(52) U.S. Cl. CPC G06Q 40/02; G06Q 30/0222; H04L 63/0807

(57) ABSTRACT

Described herein is a system for optimizing transactions conducted using a portfolio of payment devices by providing strategic content. In particular, content are assigned to payment devices in a portfolio of payment devices based on a frequency of a transaction type and a frequency with which a payment device is used. In some embodiments, a content may be generated for a payment device upon determining that a frequency of use associated with the payment device is below a usage frequency threshold. In some embodiments, a number of transactions associated with a portfolio of payment devices may be maximized by assigning content associated with transaction types that are frequently conducted to payment devices that are infrequently used as well as assigning content associated with transaction types that are infrequently conducted to payment devices that are frequently used.

### CROSS-REFERENCES TO RELATED APPLICATIONS

This application is a non-provisional application of U.S. non-provisional application Ser. No. 62/345,382, filed on Jun. 3, 2016, which is herein incorporated by reference in its entirety for all purposes.

### BACKGROUND

A transaction processing network often derives a benefit (e.g., a fee) when a transaction is conducted using its network. Accordingly, the transaction processing network is incentivized to increase the number of transactions conducted over its network and/or an amount associated with the transactions conducted over its network. To do this, transaction processing networks often provide incentives to payment device users. However, in attempting to increase transactions associated with a particular payment device, the transaction processing network often just shifts transactions from one payment device that uses its network to another. This results in the same number of transactions conducted over the network and a net loss to the transaction processing network based on costs associated with providing the incentives.

Embodiments of the invention address these and other problems, individually and collectively.

### BRIEF SUMMARY

Embodiments of the disclosure are directed to optimizing transactions conducted using a portfolio of payment devices by providing strategic content. In particular, content are assigned to payment devices in a portfolio of payment devices based on a frequency of a transaction type and a frequency with which a payment device is used. In some embodiments, a content may be generated for a payment device upon determining that a frequency of use associated with the payment device is below a usage frequency threshold. In some embodiments, this may be done automatically (e.g., without human intervention). Some example portfolio optimization methods can be found in U.S. patent application Ser. No. 12/108,342 to Lal et. al, which is herein incorporated by reference in its entirety. Additionally, some ways in which a portfolio of payment devices may be generated can be found in U.S. patent application Ser. No. 15/466,815 to Chitalia et. al, which is herein incorporated by reference in its entirety.

In some embodiments, a number of transactions associated with a portfolio of payment devices may be maximized by assigning content associated with transaction types that are frequently conducted to payment devices that are infrequently used as well as assigning content associated with transaction types that are infrequently conducted to payment devices that are frequently used. Each of the content may be associated with an incentive and a set of conditions that must be met to obtain the incentive.

One embodiment of the invention is directed to a method comprising maintaining a portfolio of payment devices, wherein each payment device in the portfolio of payment devices is associated with account information. The method further comprises identifying a plurality of content available to a user associated with the portfolio of payment devices and assigning, based on information associated with the content and account information for each payment device in the portfolio of payment devices, at least one appropriate content of the plurality of content to be associated with a payment device of the portfolio of payment devices, the appropriate content calculated to result in a transaction that would not have otherwise occurred. The method further comprises providing the at least one appropriate content to a mobile device associated with the user associated with the portfolio of payment devices.

Another embodiment of the invention is directed to a system comprising: a processor; and a memory including instructions that, when executed with the processor, cause the system to, at least receive a request to view content associated with a portfolio of payment devices, identify a plurality of content available to a user associated with the portfolio of payment devices, assign, based on information associated with the plurality of content and account information for each payment device in the portfolio of payment devices, each of the content of the plurality of content to a payment device of the portfolio of payment devices, the content assigned to the payment device such that it is calculated to result in a transaction that would not have otherwise occurred, and provide the portfolio of payment devices and the assignment of content to a mobile device associated with the user.

Yet another embodiment of the invention is directed to a mobile device comprising: a display; a processor; and a memory including instructions that, when executed with the processor, cause the mobile device to, at least receive, from a user of the mobile device, a request to provide content, the request including at least an identifier associated with the user, transmit the identifier to a mobile application server, and receive a list comprising a number of payment devices and a plurality of content from the mobile application server, each of the plurality of content assigned to a payment device of the number of payment devices. The instructions may further cause the mobile device to present the list on the display, such that the content of the plurality of content assigned to each payment device is displayed alongside the payment device, and upon receiving a selection of a payment device of the number of payment devices, enabling the user to complete a transaction using the selected payment device.

These and other embodiments of the invention are described in further detail below.

### BRIEF DESCRIPTION OF THE DRAWINGS

FIG. 1 depicts an example system in which content may be optimized for a portfolios of digital payment devices;

FIG. 2 depicts an example system architecture in which a service provider is configured to communicate with mobile devices and resource providers in order to map content offers to payment devices in accordance with at least some embodiments;

FIG. 3 depicts an example enrollment process in accordance with at least some embodiments;

FIG. 4 depicts an example process for determining portfolio optimized content and providing them to a user in accordance with at least some embodiments;

FIG. 5 depicts an illustrative example of portfolio optimized content that may be displayed to a user in accordance with at least some embodiments;

FIG. 6 depicts some example embodiments that may be implemented to include portfolio optimized content;

FIG. 7 depicts a flow diagram illustrating a process for conducting a remote transaction in accordance with at least some embodiments; and

FIG. 8 depicts a block diagram of an exemplary payment system that may utilize some embodiments of the described mobile payment device in accordance with some embodiments of the invention.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Prior to discussing the details of some embodiments of the present invention, description of some terms may be helpful in understanding the various embodiments.

An “access credential” may be any data or portion of data used to gain access to a particular resource. In some embodiments, an access credential may be a login and/or password for a user account. In some embodiments, an access credential may be include account information or a token associated with the account information, a cryptogram, a digital certificate, etc. A mobile device may store one or more access credentials associated with each communication device. In some embodiments, an access credential stored in association with a communication device may be used to conduct transactions on behalf of the communication device. In some embodiments, the mobile device may store a single access credential that may be used in each transaction initiated by the mobile device.

An “access device” may be any suitable device for communicating with a merchant computer or transaction processing network, and for interacting with a payment device, a user computer apparatus, and/or a user mobile device. An access device may generally be located in any suitable location, such as at the location of a merchant. An access device may be in any suitable form. Some examples of access devices include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a communication device. In some embodiments, where an access device may comprise a POS terminal, any suitable POS terminal may be used and may include a reader, a processor, and a computer-readable medium. A reader may include any suitable contact or contactless mode of operation. For example, card readers can include radio frequency (RF) antennas, optical scanners, bar code readers, or magnetic stripe readers to interact with a communication device. In some embodiments, an access device may also be referred to as a terminal device.

“Account data” may refer to any content of an account of a user conducting a transaction. In some embodiments, account data may be payment account data that may be utilized to make a purchase. In other embodiments, account data may be any content associated with a user's non-financial account. For example, account data may include electronic files, photos, videos, and documents stored by the user's account. In some embodiments, account data may be stored by an authorization computer.

“Account information” may refer to any information surrounding an account of a user. For example, account information may include account data and one or more account identifiers. In some embodiments, the account identifier may be a PAN or primary account number. The PAN may be 14, 16, or 18 digits. Account information may also include an expiration date associated with the account, as well as a service code and/or verification values (e.g., CVV, CVV2, dCVV, and dCVV2 values).

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to the merchant.

A “credential” may be any suitable information that serves as reliable evidence of worth, ownership, identity, or authority. A credential may be a string of numbers, letters, or any other suitable characters, as well as any object or document that can serve as confirmation. Examples of credentials include access credentials, value credentials, identification cards, certified documents, access cards, passcodes and other login information, etc.

An “issuer” may typically refer to a business entity (e.g., a bank) that maintains an account for a user that is associated with a portable communication device such as an account enrolled in a mobile application installed on a portable communication device. An issuer may also issue account parameters associated with the account to a portable communication device. An issuer may be associated with a host system that performs some or all of the functions of the issuer on behalf of the issuer.

A “mobile device” may be any electronic device configured to communicate account information to an access device to conduct a transaction. In some embodiments, the mobile device may be a mobile phone or any other suitable portable electronic device. A mobile device may include a processors and a computer readable medium. A mobile device may also include input sensors for collecting input, such as keyboards, mice, microphones, cameras, motion sensors, accelerometers, cameras, pressure sensors, thermometers, a global positioning system (GPS), a barcode reader, etc.

A “resource provider” may be an entity that can provide a resource such as goods, services, information, and/or access. Examples of a resource provider includes merchants, access devices, secure data access points, etc. A “merchant” may typically be an entity that engages in transactions and can sell goods or services, or provide access to goods or services.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “token” may be a substitute for a real credential. In some embodiments, a token may include an identifier for a payment account that is a substitute for a real credential such as primary account number (PAN). For example, a token may include a series of numeric and/or alphanumeric characters that may be used as a substitute for an original account identifier. For example, a token “4900 0000 0000 0001” may be used in place of a PAN “4147 0900 0000 1232.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. In other embodiments, a token may be mathematically derived (e.g., with an encryption key) from the real credential. Further, in some embodiments, the token format may be configured to allow the entity receiving the token to identify it as a token and recognize the entity that issued the token.

A “token provider” or “token service system” can include one or more computers that service payment tokens. In some embodiments, a token service system can facilitate requesting, determining (e.g., generating) and/or issuing tokens, as well as maintaining an established mapping of tokens to primary account numbers (PANs) in a repository (e.g. token vault). In some embodiments, the token service system may establish a token assurance level for a given token to indicate the confidence level of the token to PAN binding. The token service system may include or be in communication with a token vault where the generated tokens are stored. The token service system may support token processing of payment transactions submitted using tokens by de-tokenizing the token to obtain the actual PAN. In some embodiments, a token service system may include a tokenization computer alone, or in combination with other computers such as a transaction processing network computer. Various entities of a tokenization ecosystem may assume the roles of the token service provider. For example, payment networks and issuers or their agents may become the token service provider by implementing the token services according to embodiments of the present invention.

A “transaction” may be any interaction or exchange between two or more entities. For example, a transaction may include a first electronic device (e.g., a client device) requesting resources from a second electronic device (e.g., a resource provider). In this example, the transaction is completed when the resources are either provided to the first electronic device or the transaction is declined.

A “transaction data” may be any information related to a transaction between two entities. Transaction information may include information related to a completed transaction or a transaction that has not yet been completed. In some embodiments, the transaction information may include any suitable information related to a context of the transaction. For example, the transaction information may include a time at which the transaction was conducted, a terminal at which the transaction was conducted, an amount for which the transaction was conducted, an indication of an entity with whom the transaction was conducted, or any other suitable transaction-related information.

A “transaction processing network” (e.g., VisaNet®) may include data processing subsystems, networks, and operations used to support and deliver authorization services, exception file services, and clearing and settlement services. An exemplary transaction processing network may include VisaNet®. Transaction processing networks such as VisaNet® are able to process credit card transactions, debit card transactions, and other types of commercial transactions. VisaNet® in particular, includes a VIP system (Visa Integrated Payments system) which processes authorization requests and a Base II system which performs clearing and settlement services.

Details of some embodiments of the present invention will now be described.

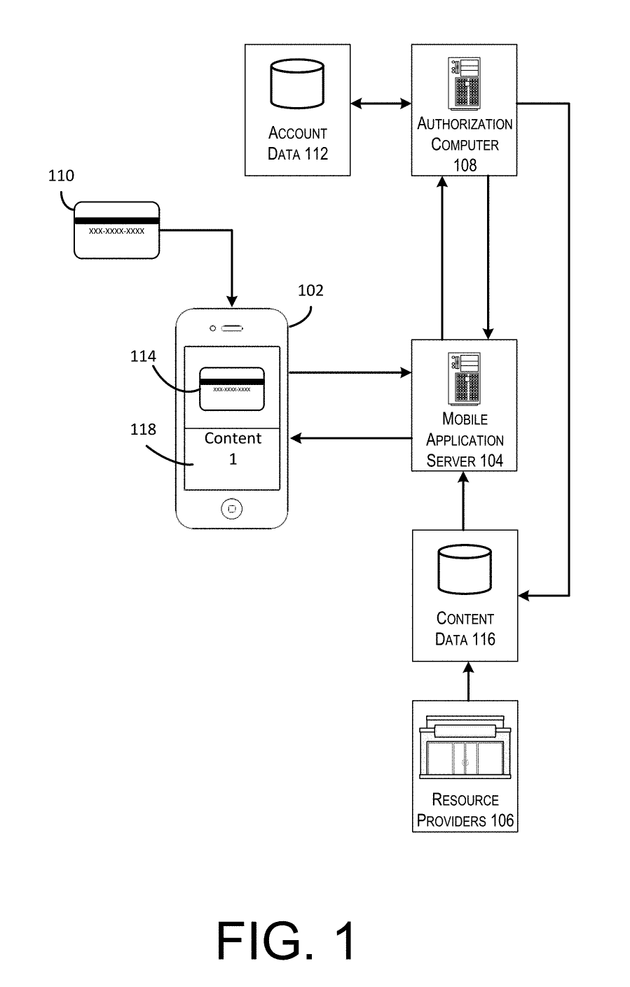

FIG. 1 depicts an example system in which content may be optimized for a portfolios of digital payment devices. In FIG. 1, a mobile device 102 may be in communication with a mobile application server 104. The mobile application server 104 may be any computing device configured to provide backend support for the mobile device 102 or an application installed on the mobile device 102. For example, the mobile device 102 may have stored upon it an ewallet application. In this example, the mobile application server 104 may provide token information and/or at least a portion of the processing required by the ewallet application. The mobile application server 104 may be in communication with multiple resource provider (e.g., merchant) computers 106. Additionally, the mobile application server 104 may be in communication with an authorization computer 108 which maintains account information for a number of payment devices. The mobile application server 104 may be affiliated with the authorization computer 108. For example, each of the mobile application server 104 and the authorization computer 108 may be owned and/or operated by the same entity.

In some embodiments, each of the entities depicted may communicate via any one or a combination of many different types of networks, such as cable networks, the Internet, wireless networks, cellular networks, and other private and/or public networks. For example, the mobile device 102 may utilize a 3G network to communicate with a wireless router, which may then route the communication over a public network (e.g., the Internet) to the mobile application server 104. In some embodiments, the entities may communicate via a transaction processing network.

In the example system depicted, during an enrollment process, a user may enter information associated with a payment device 110 into an interface of the mobile device 102. The mobile device 102 may communicate the input payment device information to the mobile application server 104. In some embodiments, a user of the mobile device 102 may be required to log into an account maintained by the mobile application server 104 in order to begin the enrollment process or otherwise access features of a mobile application supported by the mobile application server 104.

Upon receiving the information associated with a payment device 110, the mobile application server 104 may identify an authorization computer 108 associated with the payment device. In some embodiments, the authorization computer 108 may be identified based on a format of an account number received by the mobile application server 104. The mobile application server 104 may establish a communication session with the identified authorization computer 108 in order to request additional information related to the payment device 110 from the issuer. The mobile application server 104 may provide the information related to the payment device 110 that it received from the user to the authorization computer 108 in order to access an account associated with the payment device 110. In some embodiments, the user may be required to enter a password or PIN code before a communication session may be established.

Upon receiving the payment device 110 information, the authorization computer 108 may query an account database 112 to identify additional information related to the payment device 110. The authorization computer 108 may provide the additional data to the mobile application server 104, which may store the information in association with the payment device and may subsequently forward at least a portion of that information to the mobile device 102. In some embodiments, the information may include user preferences associated with the payment device, rewards program data, spending limits, an account balance, transaction history data, or any other information associated with the payment device. In some embodiments, the authorization computer 108 may provide an image of the payment device 114, which may subsequently be displayed by the mobile device in relation to the payment device 110. Upon completion of the enrollment process, the information provided to the mobile application server 104 may be maintained in the account associated with the user. In some embodiments, the mobile application server 104 may periodically communicate with the authorization computer 108 to update the information.

The mobile application may maintain a database of content data 116. In some embodiments, the content data 116 may comprise information provided by a number of resource providers 106. In some embodiments, the content data 116 may comprise information provided by an authorization computer 108. Content data 116 may comprise information related to special deals, coupons, discounts, bonuses, or any other suitable incentive. In some embodiments, the mobile application server 104 and/or the mobile device 102 may match content information in the content data 116 to a particular payment device 110 for a user in order to incentivize that user to utilize the particular payment device 110. In some embodiments, the content information 118, once matched, may be sent to the mobile device 102 (e.g., via a push notification) and subsequently presented to a user of the mobile device 102.

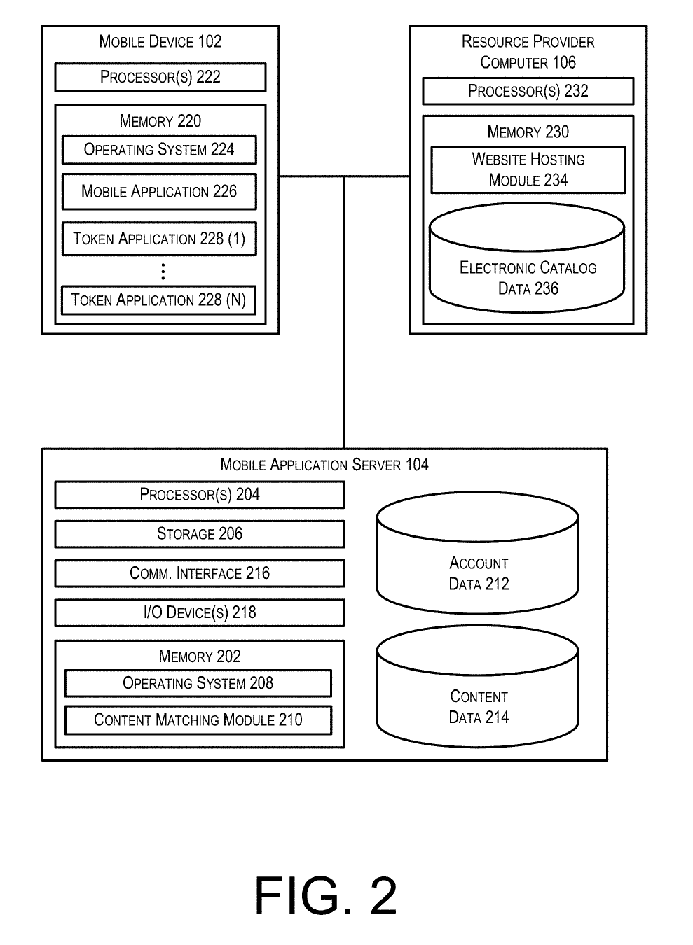

FIG. 2 depicts an example system architecture in which a service provider is configured to communicate with mobile devices and resource providers in order to map content offers to payment devices in accordance with at least some embodiments. Depicted in FIG. 2 is a mobile application server 104 in communication with a mobile device 102 and a resource provider computer 106.

The mobile application server 104 may be an example of mobile application server 104 as depicted in FIG. 1. In at least some embodiments, the mobile application server 104 may include at least one memory 202 and one or more processing units (or processor(s)) 204.

The memory 202 may store program instructions that are loadable and executable on the processor(s) 204, as well as data generated during the execution of these programs. Depending on the configuration and type of mobile application server 104, the memory 202 may be volatile (such as random access memory (RAM)) and/or non-volatile (such as read-only memory (ROM), flash memory, etc.). The mobile application server 104 may also include additional storage 206, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the mobile application server 104. In some embodiments, the memory 202 may include multiple different types of memory, such as static random access memory (SRAM), dynamic random access memory (DRAM) or ROM.

Turning to the content of the memory 202 in more detail, the memory 202 may include an operating system 214 and one or more application programs or services for implementing the features disclosed herein including at least a module for mapping content data to payment applications and providing the content to a mobile device 102 (content matching module 210). The memory 202 may also include account data 212, which includes information on mappings between mobile devices and user accounts and/or content data 214, which includes information on content provided by one or more resource provider computers 106.

In some embodiments, the content matching module 210 may, in conjunction with the processor 204, be configured to parse transaction history data associated with each payment device in a set of payment devices to determine a frequency of use for that payment device as well as transaction types frequently conducted (e.g., preferred transaction types) with respect to that payment device. The content matching module 210 may be configured to compile a portfolio of payment devices associated with a particular user. In some embodiments, this may be done by receiving payment device information from one or more authorization entities (e.g., issuers). In some embodiments, this may be done by receiving an indication of various payment devices from a mobile device 102. For example, the mobile device 102 may transmit a list of credit card numbers stored in memory 220 and/or token applications 228 installed on the mobile device 102.

In some embodiments, the content matching module 210 may, in conjunction with the processor 204, be configured to map eligible content from the content data 214 to payment devices in the portfolio of payment devices to determine a value of the incentives associated with each mapping (e.g., the sum of the reward points, cash back, etc.). In some embodiments, the content matching module 210 may, in conjunction with the processor 204, attempt to generate a set of optimized payment device/content pairings, such that the costs of providing the incentives in the content are offset by the benefit gained by fulfillment of the conditions of the content. In some embodiments, the content matching module 210 may, in conjunction with the processor 204, map content to payment devices based on frequency of use and preferred transaction types. For example, payment devices that are frequently used may be mapped to content associated with transaction types that are infrequently conducted by the user (ensuring that fulfillment of the content is calculated to result in a transaction that would not have otherwise occurred). In this example, payment devices that are infrequently used may be mapped to content associated with transaction types that are frequently conducted by the user.

The mobile application server 104 may also contain communications interface(s) 216 that enable the mobile application server 104 to communicate with a stored database, another computing device or server, one or more remote devices, other application servers, and/or any other suitable electronic devices. In some embodiments, the communication interface 216 may enable the mobile application server 104 to communicate with other electronic devices on a network (e.g., on a private network). The mobile application server 104 may also include input/output (I/O) device(s) and/or ports 218, such as for enabling connection with a keyboard, a mouse, a pen, a voice input device, a touch input device, a display, speakers, a printer, etc.

The mobile device 102 may be an example of mobile device 102 as depicted in FIG. 1. In some embodiments, the mobile device 102 may comprise any portable electronic device capable of communicating with the mobile application server 104. The mobile device 102 may include a memory 220 (e.g., a computer-readable storage medium) storing instructions that, when executed by a processor 222 of the mobile device 102, allow the client device to perform its intended functions. Turning to the content of the memory 220 in more detail, the memory 220 may include an operating system 224 that provides executable program instructions for the general administration and operation of the mobile device 102, and one or more mobile applications, at least one of which may be configured to cause the mobile device 102 to communicate with the mobile application server 104 in order to receive content information from a resource provider computer 106 (e.g., mobile application 226). Additionally, the mobile device 102 may have in memory 224 at least one application configured to generate tokens for use in completing a transaction (e.g., token application 228). In some embodiments, a token application 228 may be referred to as an e-wallet application. The memory 220 may include multiple token applications 228 (e.g., 1-N).

In some embodiments, a token application 228 may be a payment device for the purposes described herein. In these embodiments, an indication of the token application may be included in a portfolio of payment devices associated with the mobile device 102 and/or a user. A token application 228 may be configured to, in conjunction with a processor 222, generate or obtain a token to be used in a transaction. In some embodiments, the token application 228 may authenticate a user of the mobile device 102 before generating a token. To do this, the token application 228 may, in conjunction with the processor 222, obtain biometric information from the user (e.g., a fingerprint or voiceprint) via an input sensor installed on the mobile device 102 to be compared to biometric information stored in relation to the user. Upon verifying that the user is authorized to access the token application 228, the user may be prompted to select a payment option (e.g., a credit card or bank account). The token application 228 may, in conjunction with the processor 222, then be configured to generate or otherwise obtain a token to be used in completing a transaction. The token application 228, in conjunction with the processor 222, may transmit the mapping between the transaction and the token to a token application server that provides backend support for the token application 228. In other embodiments, the mobile device 102 may receive the token from the token application server and need not transmit the token to that token application server.

In some embodiments, the mobile application 226 installed on the mobile device 102 may, in conjunction with the processor 222, identify a number of token applications 228 available to a user of the mobile device 102. For example, token applications 228 (1-N) may be identified as being available to the user of a mobile device 102. In some embodiments, the mobile application 226 and the processor 222 may detect cookies installed on the mobile device by each of the token applications 228 (1-N). The cookies identified in relation to the token applications 228 may include data for those token applications 228. For example, the cookie for an token application 228 (1-N) may include a name, or other identifier, of the token application 228 (1-N). The cookie may also include a graphic to be associated with the token application 228 (e.g., a logo or icon image). In some embodiments, the token application 228 (1-N) may be enrolled in a program implemented by the mobile application server 104. In some embodiments, the mobile application server 104 may maintain, in relation to a user account, a number of wallet application identifiers associated with the user. Each token application 228 (1-N) may be associated with a corresponding remote token provider server computer that maintains account information for a wallet account associated with that token application 228. In some embodiments, the mobile application server 104 and/or the mobile application 226 may maintain login information for the various token applications 228 (1-N) which may be used to access accounts maintained either locally (i.e., on the mobile device 102) or remotely.

In some embodiments, a resource provider computer 106 may be an example resource provider computer 106 as depicted in FIG. 1. The resource provider computer 106 may include a memory 230 (e.g., a computer-readable storage medium) storing instructions that, when executed by a processor 232 of the resource provider computer 106, allow the resource provider computer 106 to perform its intended functions. In particular, the memory 230 may include a module for maintaining and serving webpages to one or more client devices that access the resource provider computer 106 via an internet connection (e.g., website hosting module 234). In some embodiments, the resource provider computer 106 may maintain an electronic catalog 236 that includes a set of goods and/or services offered by that resource provider. The resource provider computer 106 may be configured to enable a user of a website hosted by the computer 106 to conduct a transaction for a product (e.g., a good or service) maintained in the electronic catalog 236. The resource provider computer 106 may also comprise an authorization module that may be programmed to cause the resource provider computer 106 to generate authorization request messages, and receive authorization response messages. Additionally, the resource provider computer 106 may be configured to identify content (e.g., advertisements or other suitable offers) related to items in the electronic catalog data 236 to be provided to the mobile application server 104. In some embodiments, content provided to the mobile application server 104 may be associated with one or more conditions. In some cases, the content may be associated with ranges of values. For example, users meeting a first set of conditions may be eligible for a discount of a first value whereas users meeting a second set of conditions may be eligible for a discount of a second value.

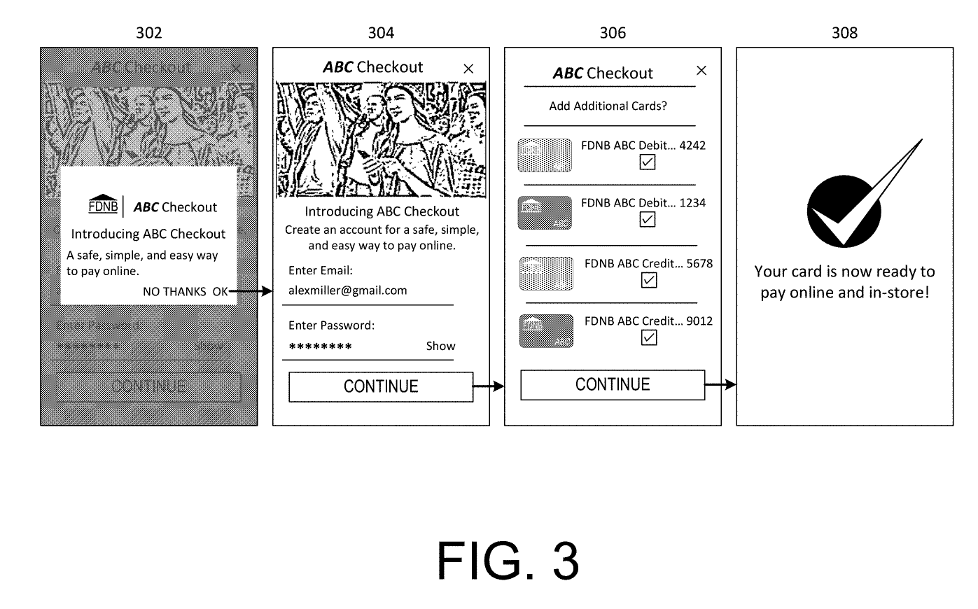

FIG. 3 depicts an example enrollment process in accordance with at least some embodiments. In some embodiments, an account maintained by a server (e.g., the mobile application server 104 of FIG. 1) may be associated with a number of payment devices (a portfolio of payment devices). In these embodiments, a user may be given the ability to log into the account using a mobile device. For example, the user may log into the account directly via an interface of a mobile application. In another example, the user may log into the account via a webpage depicted by a browser application. Once the user is authenticated (e.g., by successfully logging in), the payment devices associated with the user may be linked to the mobile device from which the user logged in. In some embodiments, tokens associated with each of the linked payment devices may be provisioned onto the mobile device for future transactions.

In various embodiments, a user may be presented with a number of user interfaces (UIs) based on his or her interaction with the described system. In UI 302, the user may be presented with the option to enroll, or otherwise participate, in a checkout mobile application which may be used to complete transactions. For example, the user may select an option displayed on merchant checkout page to use the checkout mobile application to complete a transaction. In this example, the mobile application server may determine that the user does not currently have an account.

Upon receiving an indication that the user wishes to enroll into an account maintained by the checkout mobile application, the mobile application server may present UI 304, in which the user may be prompted to provide an identifier. For example, the user may be asked to provide an email address, name, or other suitable identifying information. In addition, the mobile application server may be provided with identifying information by the mobile device from which the user has elected to use the checkout mobile application. For example, the mobile device 102 may provide a current location, device identifiers (e.g., serial number and/or phone number), user name, and/or a list of payment devices.

In some embodiments, the mobile application server may be configured to generate a list of payment devices for a user account based on the provided identifier. For example, upon receiving the identifier provided by the user, the mobile application server may contact a number of authorization entity computers in order to obtain account information. In this example, the mobile application server may transmit the identifier to multiple authorization entity computers and each of those authorization entity computers may query a database for user accounts, and corresponding payment devices, associated with that identifier. The mobile application server may then compile a master list that includes each of the payment devices indicated by the authorization entity computers as well as any payment devices received from the mobile device 102. Each of the payment devices within the list of payment devices may then be linked to the user's account. The list of payment devices may be presented to the user via UI 306. In some embodiments, the user may be asked to authenticate himself/herself with one or more of the authorization entities before payment device information may be provided. It should be noted that some embodiments of the system described herein may generate the list of payment devices automatically (e.g., without manual indication of payment devices by the user) using only the provided identifier. Once a complete set of payment devices has been added to the account, UI 308 may be presented to the user to indicate that the account has been created.

During the depicted example enrollment process, information associated with each of the payment devices that are linked to the account may be retrieved by the server. This information may be stored in association with each of the respective payment devices and subsequently used to optimize content for the portfolio of payment devices. In some embodiments, the account maintained by the server may retrieve user preference data for the account.

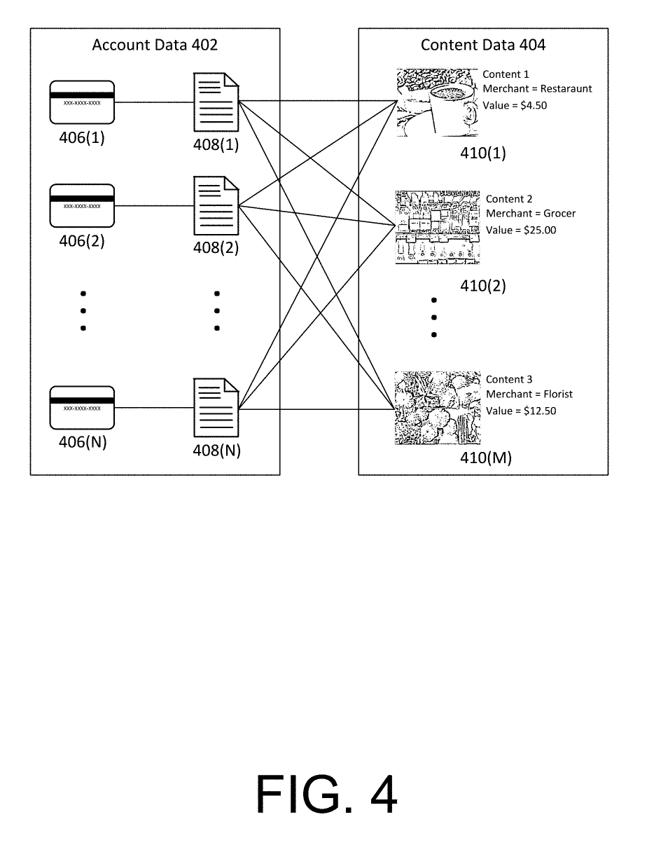

FIG. 4 depicts an example process for determining portfolio optimized content and providing them to a user in accordance with at least some embodiments. In FIG. 4, a server and/or mobile device may maintain account data 402 and content data 404. The server may compare the data in both of these data stores to determine optimized content for a payment device portfolio.

Account data 402 may include information associated with a number of payment devices 406(1-N) and policies and usage data 408(1-N) associated with the payment devices 406. Each of the payment devices 406 may be associated with a token or other account representation that may be provided to a mobile device in order to complete transactions. Payment device policies and usage data 308 may include information on user preferences associated with the payment device, rewards program data, spending limits, an account balance, transaction history data, or any other information associated with the payment device.

Content data 404 may include information related to merchants, reward point programs, issuer incentives, transaction processing network incentives, or any other suitable information. Content data may comprise a plurality of content 310(1-M). In some embodiments, a content may include an image, conditions to be satisfied, an incentive for meeting the conditions, an indication of eligible payment devices and/or users, an indication of a merchant or type of merchant affiliated with the content, and any other suitable content-related information.

In accordance with at least some embodiments, a system (e.g., a server and/or a mobile device) may filter content in the content data 404 to remove any for which the user is not eligible (e.g., the user does not meet predefined user criteria such as income level, credit limit, demographics, etc.). In addition, content may be filtered according to user preferences associated with the account and or payment device. For example, the user may indicate that he or she does not wish to receive certain types of content or content from specified merchants. In some embodiments, content may also be limited to particular payment devices. For example, merchants may only accept payment devices that utilize a particular transaction processing network. In this example, content from that merchant may be available to be matched to only those payment devices. Eligible content are then identified in the remaining content data 404.

In some embodiments, the system may parse transaction history data associated with each payment device to determine a frequency of use for each payment device as well as transaction types frequently conducted (preferred transaction types). In some embodiments, each of the eligible content may be matched to payment devices in the portfolio to determine a value of the incentives associated with each matching (e.g., the sum of the reward points, cash back, etc.). In some embodiments, the system may attempt to generate a set of optimized payment device—content pairings, such that the costs of providing the incentives in the content are offset by the benefit gained by fulfillment of the conditions of the content. In some embodiments, content may be matched to payment devices based on frequency of use and preferred transaction types. For example, payment devices that are frequently used may be matched to content associated with transaction types that are infrequently conducted by the user (ensuring that fulfillment of the content is calculated to result in a transaction that would not have otherwise occurred). In this example, payment devices that are infrequently used may be matched to content associated with transaction types that are frequently conducted by the user.

In some embodiments, content may be matched to payment devices based on reward program requirements. For example, if a reward program affiliated with a payment device offers triple rewards for dining out, then content that includes an offer for a discount at a restaurant may be given greater weight in determining whether it should be matched to that payment device. In some embodiments, content that the user is more likely to use may be identified. For example, transaction histories associated with the payment devices may be parsed to identify a type of transaction that the user conducts frequently. In this example, content associated with the identified type of transaction may be given greater weight when being matched to payment devices that are infrequently used.

New content may also be generated to be associated with a payment device. In some embodiments, a cost associated with providing an incentive may be calculated and weighed against a benefit gained from providing that incentive to determine if there is a net benefit of providing the content. For example, a transaction processing network may obtain a fee payment each time that a payment device is used to conduct a transaction. In this example, an incentive may be provided to a user to conduct a transaction if the fee payment to be obtained is greater than the cost of providing the incentive. By way of illustration, consider a scenario in which the server is determining a number of transactions that need to be conducted in order to content a user $5. In this illustration, the transaction processing network may obtain a $0.93 fee each time that a payment device is used in a transaction. The transaction processing network may determine that the user will need to conduct six transactions (for a total of $5.58) in order for the content to provide a net benefit. In this illustration, a content may be generated to indicate that a user will be provided $5 if the user conducts six transactions by a certain date. In another example, a particular merchant may offer a commission to drive sales toward that merchant. In this example, the system may generate a content with conditions that a payment device be used in a transaction at that merchant.

In some embodiments, content may be provided in order to incentive users to activate a payment device or use payment devices that have not been used recently. For example, a transaction history associated with each payment device may be parsed to determine if a latest transaction for that payment device is before a date threshold. Upon determining that the latest transaction for a payment device is before a date threshold, a content may be generated for that payment device. In some embodiments, content may be generated for a payment device upon determining that a balance due is above or below a balance threshold. In some embodiments, content may be generated automatically (e.g., without human intervention).

By way of illustration, consider a scenario in which a particular payment device has not been utilized in over six months. In this scenario, the system may have a policy to automatically generate a content for payment devices that have not been used in at least six months. The system may identify a content in content data 404 that the user is likely to be interested in (e.g., the user often conducts transactions similar to the one associated with the content). For example, the user may frequently dine in restaurants and the system may identify a content for triple reward points for eating in a particular restaurant. The system may then link a set of conditions associated with the content (e.g., eat at the particular restaurant by a certain date) to the payment device. The system may then provide the content to a mobile device operated by the user (e.g., via a push notification).

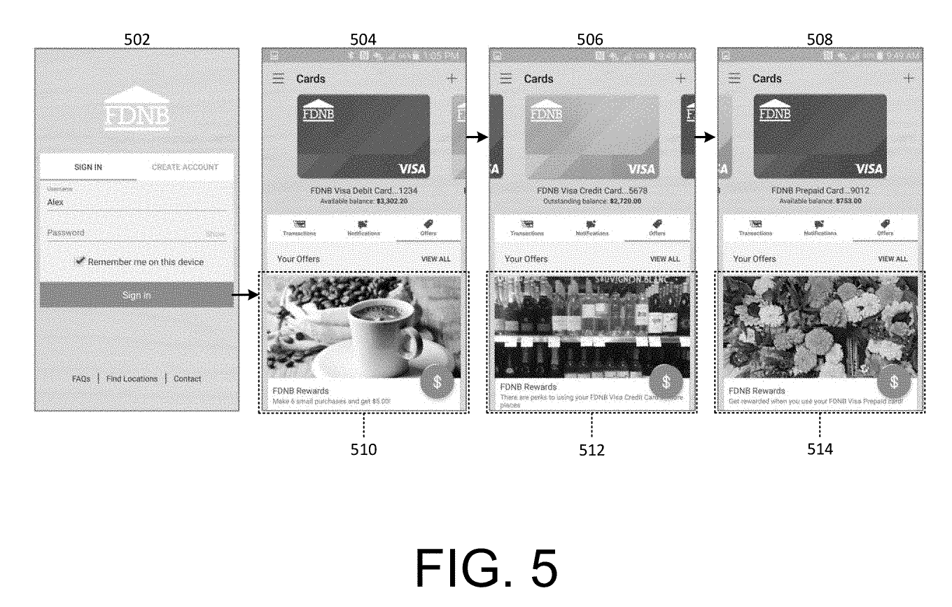

FIG. 5 depicts an illustrative example of a mobile application that provides portfolio optimized content to a user in accordance with at least some embodiments. In FIG. 5, a number of payment devices may be displayed to the user via a graphical user interface (GUI) of a mobile application stored on, and executed from, a mobile device. The mobile application may be in communication with a mobile application server that maintains an account associated with a user and/or the mobile device. In some embodiments, the user may be required to log into an account maintained by mobile application server via a login UI 502.

In some embodiments, a user is provided the ability to select a payment device from a portfolio of payment devices (e.g., by scrolling through separate screens for each payment device). The user is able to identify, in relation to each payment device, information associated with the payment device as well as any relevant content (e.g., offers) associated with that payment device. In some embodiments, multiple content may be associated with a single payment device. In some embodiments, a single content may be associated with multiple payment devices. For example, a user may select a payment device by swiping through UIs 504, 506, and 508, each of which may be associated with a different payment device. Each of the UIs 504, 506, and 508 may include content 510, 512, and 516 associated with each of the payment devices

In some embodiments, the mobile application may include instructions that cause a processor to retrieve a token associated with a particular payment device. For example, the user may select a payment device of the portfolio of payment devices and select an option to make a payment using the payment device. Alternatively, a token associated with the payment device may be retrieved when the payment device is selected (e.g., when the user scrolls to the payment device). Once the token associated with the payment device has been retrieved, the user may present the mobile device as payment to a merchant (e.g., via an access device).

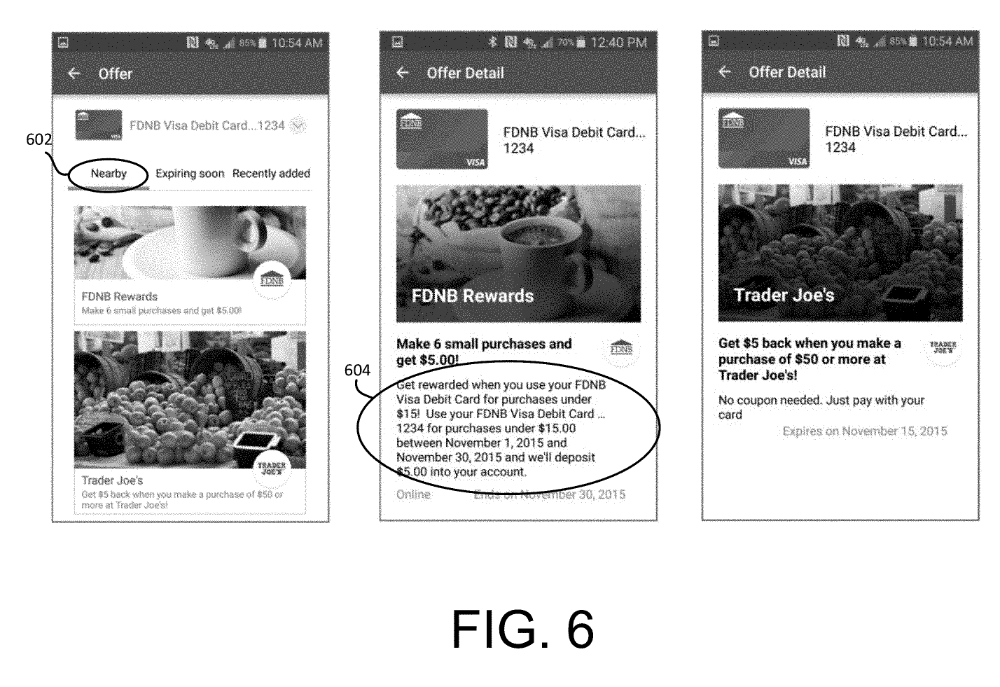

FIG. 6 depicts some example features that may be implemented with portfolio optimized content in accordance with at least some embodiments. Although FIG. 6 depicts a number of features (some of which are illustrated in FIG. 6 but not described).

In some embodiments, the content associated with a payment device may be filtered according to one or more criteria 602. Criteria 602 may be actively selected (e.g., the user may select an option on the GUI) by a user or it may be set in configuration settings associated with the payment device and/or account. For example, the user may indicate a type of content with respect to which he or she would like to receive a notification. In this example, the user may be provided with a notification each time that a content of the indicated type becomes available.

In some embodiments, the content 604 may comprise various conditions and an incentive for meeting the various conditions. In some cases, the user may not be required to formally accept the content in order to be provided with the incentive. For example, conditions associated with a content may require that the user utilize a particular payment device at a particular merchant to be provided with the indicated incentive. In some embodiments, a user may be required to accept a content displayed on the mobile device.

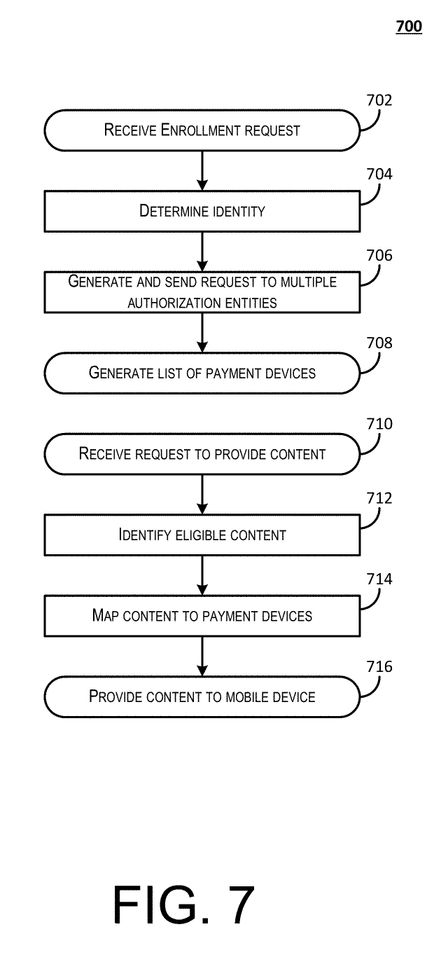

FIG. 7 depicts a flow diagram illustrating a process for conducting a remote transaction in accordance with at least some embodiments. In at least some embodiments, process 600 may be performed by a mobile application server 104 as depicted in FIG. 1.

Process 700 may begin at 702, when the mobile application server receives an enrollment request. In some embodiments, the enrollment request may be received via a website that the mobile application server maintains. In some embodiments, the enrollment request may be received via a mobile application installed upon a mobile device. For example, a user may initiate a transaction on a merchant's website. In this example, the user may select an option to use a checkout application associated with the mobile application server to complete the transaction. Upon receiving an indication that the option has been selected, the mobile application server may determine whether the user is currently associated with an account maintained by the mobile application server.

At 704, the mobile application server may identify a user associated with the enrollment request. In some embodiments, the request may include an identifier that may be used to identify an account associated with the user. For example, the request may include an email address that may be mapped to a user account. In some embodiments, the mobile application server may store an identifier for the user. Upon the mobile application server identifying the account associated with the user, the mobile application server may retrieve the identifier to be used in generating the requests to the authorization entities.

At 706, the mobile application server may generate a number of requests for payment device information, which the mobile application server may route to computers operated on behalf of various authorization entities. For example, the mobile application server may identify a number of authorization entities that may maintain an account for the user. The mobile application server may generate requests to each of the identified authorization entities. In some embodiments, this may involve identifying one or more application programming interfaces (APIs) associated with the authorization entities. In these embodiments, the mobile application server may implement one or more routines included in the APIs to communicate with the authorization entity computers. Each of the authorization entities may then respond to the mobile application server with an indication of whether the user has an account with that authorization entity as well as a number of payment devices associated with that account. In some embodiments, the mobile application server may maintain a list of payment devices associated with a user.

At 708, the mobile application server may generate a list (e.g., a portfolio) of payment devices to be associated with the account. The mobile application server may provide that list to a user device associated with the account (e.g., the user device from which the request was received) so that a user may select a payment device from that list to complete a transaction. In some embodiments, the user may be provided the opportunity to add a payment device to the portfolio of payment devices manually. The portfolio of payment devices may be maintained by the mobile application server in relation to the user's account. In some embodiments, the portfolio may be periodically updated by transmitting requests to a number of authorization entities.

At 710, the mobile application server may receive a request to provide content to a user device. In some embodiments, the request may be generated automatically (e.g., without any user interaction). For example, the system may periodically send content to one or more users. In some embodiments, the request may be generated upon the user opening a mobile application installed upon the user's mobile device. In some embodiments, the request may be generated upon the user selecting a checkout option on a merchant webpage that involves the user's account with the mobile application server.

At 712, the mobile application server may identify a plurality of eligible content. The content may include any content provided by a resource provider computer, which may be an advertisement server. In some embodiments, eligible content may be content associated with conditions determined to be met by the user. For example, some content may be directed to users that fit within a particular category (e.g., age, sex, income level, etc.). In this example, eligible content may be content for which the user fits within that category. In some embodiments, the eligible content may be associated with a range of dates. For example, the eligible content may include offers that are good for a specified period of time. In some embodiments, content may be ranked in relation to a user based on that user's likelihood of being interested in that content. For example, the mobile application server may use one or more recommendation engines and/or machine learning algorithms to ascertain user preferences.

At 714, the mobile application server may map the plurality of eligible content to payment devices in the portfolio of payment devices associated with the user's account. The mobile application server may assign at least one appropriate content of the plurality of content to be associated with a payment device of the portfolio of payment devices based on information associated with the content and account information for each payment device in the portfolio of payment devices. In some embodiments, the content may be assigned to a payment device such that it is calculated to result in a transaction that would not have otherwise occurred. For example, the mobile application server may select a content that is likely to be selected by the user and may assign that content to a payment device that is rarely used by the user.

In some embodiments, the mobile application server may determine a frequency of use for each payment device in the portfolio of payment devices. For example, the mobile application server may determine a number of transactions conducted using the payment device over for a given period of time (e.g., within the last 30 days). In some embodiments, the mobile application server may determine a last-used date for a payment device that includes a date upon which the last transaction involving the payment device was conducted. The mobile application server may categorize, or otherwise sort, payment devices using one or more date thresholds. For example, the mobile application server may identify payment devices last used more than 90 days ago, payment devices last used more than 60 days ago, payment devices last used more than 30 days ago, and currently used payment devices. The mobile application server may then assign content to each of the payment devices in the portfolio based on the frequency-of-use data and/or the categorization of those payment devices. For example, the mobile application server may assign the content that would be most appealing to the user associated with the account to the payment devices least frequently used.

At 716, the mobile application server may provide the content mappings to the mobile device. In some embodiments, the content mappings may include at least an incentive and one or more conditions to be met by a user in order to obtain the incentive. In some embodiments, content may be provided to the mobile device such that it is displayed alongside an associated payment device.

Once the content has been provided to the mobile device, the mobile application server may monitor transactions that occur using the payment devices to detect when conditions associated with the content have been satisfied. This may involve monitoring authorization request messages transmitted over a transaction processing network. The mobile application server may identify transaction details associated with each of the received authorization request messages to determine which, if any, conditions associated with the provided content have been met. In some embodiments, the mobile application server may only identify conditions that have been met with respect to content that was actually provided to a user. For example, even if a transaction conducted by the user meets all of the conditions of a particular piece of content, an incentive offered in that particular piece of content may not be provided unless the content was actually presented to the user. Additionally, the mobile application server may only provide an incentive to the user if the conditions are met using the payment device assigned to the content.

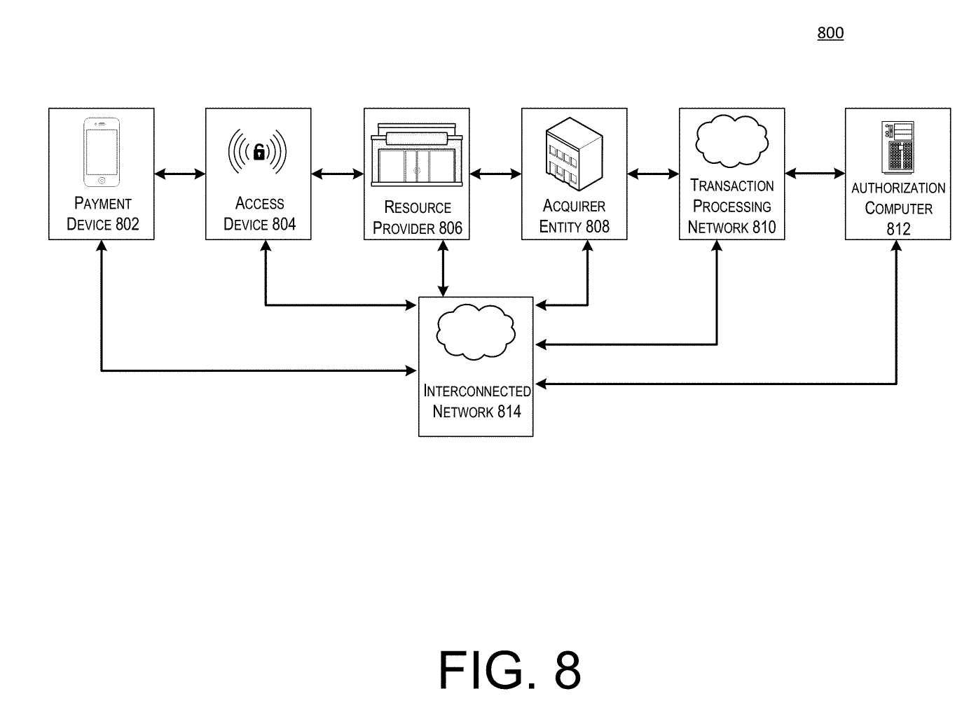

FIG. 8 depicts a block diagram of an exemplary payment system that may utilize some embodiments of the described mobile payment device in accordance with some embodiments of the invention. The system 800 may include a payment device 802, an access device 804, a resource provider 806, an acquirer entity 808, a transaction processing network computer 810, and an authorization computer 812. In some implementations, different entities in FIG. 8 may communicate with each other using one or more communication networks such as the Internet, a cellular network, a TCP/IP network or any other suitable communication network. The system shown in FIG. 8 and the payment process described below may be integrated with the embodiments depicted in and described with respect to any of the previous figures.

The payment device 802 may be associated with a payment account of a user. In some implementations, the payment device 802 may be a mobile device such as a mobile phone, a tablet, a PDA, a notebook, a key fob, a vehicle such as an automobile, or any suitable mobile device. In some embodiments, the payment device 802 may be a wearable device such as, but not limited to, a smart watch, a fitness band, an ankle bracelet, a ring, earrings, etc. For example, the payment device 802 may include a virtual wallet or a payment application that may be associated with one or more payment accounts of the user. In some implementations, the payment device 802 may be capable of communicating with the access device 804 using a wireless data protocol such as WiFi® or Bluetooth®. For example, the payment device 802 may interact with the access device 804 by establishing a connection with the access device 804 using a wireless data protocol. In some embodiments, the payment device 802 may be linked to a user account associated with a plastic card.

The access device 804 may be an access point to a transaction processing system that may comprise the acquirer entity 808, the transaction processing network computer 810, and the authorization computer 812. In some implementations, the access device 804 may be associated with or operated by the resource provider 806. For example, the access device 804 may be a point of sale device that may include a contactless reader, an electronic cash register, a display device, etc. In some implementations, the access device 804 may be configured to transmit information pertaining to one or more purchased items at a resource provider 806 to an acquirer 804 or transaction processing network 810. In some implementations, the access device 804 may be a personal computer that may be used by the user to initiate a transaction with the resource provider 806 (e.g., an online transaction).

The acquirer entity 808 may be operated by an acquirer. An acquirer is typically a system for an entity (e.g., a bank) that has a business relationship with a particular merchant, a wallet provider or another entity. The acquirer entity 808 may be communicatively coupled to the resource provider 806 and the transaction processing network 810 and may issue and manage a financial account for the merchant. The acquirer entity 808 may be configured to route the authorization request for a transaction to the authorization computer 812 via the transaction processing network computer 810 and route an authorization response received via the transaction processing network computer 810 to the resource provider 806.

The transaction processing network computer 810 may be configured to provide authorization services, and clearing and settlement services for payment transactions. The transaction processing network computer 810 may include data processing subsystems, wired or wireless networks, including the internet. An example of the transaction processing network computer 810 includes VisaNet®, operated by Visa®. Transaction processing networks such as VisaNet® are able to process credit card transactions, debit card transactions, and other types of commercial transactions. VisaNet®, in particular includes a Visa Integrated Payments (VIP) system which processes authorization requests and a Base II system which performs clearing and settlement services. The transaction processing network computer 810 may include a server computer. In some implementations, the transaction processing network computer 810 may forward an authorization request received from the acquirer entity 808 to the authorization computer 812 via a communication channel. The transaction processing network computer 810 may further forward an authorization response message received from the authorization computer 812 to the acquirer entity 808. In some implementations, the transaction processing network 810 may operate the mobile application server 104 of FIG. 1 or provide a software application configured to run on the mobile device 102 of FIG. 1.

The authorization computer 812 may represent an account issuer and/or an issuer processor. Typically, the authorization computer 812 may be associated with a business entity (e.g., a bank) that may have issued an account and/or payment card (e.g., credit account, debit account, etc.) for payment transactions. In some implementations, the business entity (bank) associated with the authorization computer 812 may also function as an acquirer (e.g., the acquirer entity 808).

The authorization computer 812 and/or the transaction processing network computer 810 may operate as authorization systems in some embodiments of the invention. For example, a transaction may be authorized by the authorization computer 812 and/or the transaction processing network computer 810 upon successful authentication of the user and verification of sufficient funds associated with the payment device 102.

In accordance with at least some embodiments, the transaction processing network computer 810 and/or the authorization computer 108 may determine whether conditions associated with a particular content have been satisfied. Upon determining that each of the conditions associated with a particular content have been met, an incentive associated with the content may be released to the user. In some embodiments, the incentive may not be released until the transaction has been settled by the authorization computer 108.

The various entities in the system 800 may communicate with each other using any suitable communication mechanism. For example, the entities in the system 800 may communicate via an interconnected network 814, e.g., the Internet.

Embodiments of the invention provide for a number of technical advantages over conventional systems. For example, content may be optimized for each payment device such that a user may easily maximize his or her use of a reward point program. Furthermore, users are incentivized to use payment devices that the user would not normally use, spurring additional transactions associated with inactive accounts. Embodiments of the disclosure better enable issuers and transaction processing networks to influence transactions conducted by the user. For example, in recent testing, portfolio optimization techniques using mobile devices have resulted in increased transaction volume equivalent to or greater to the results achieved via email.

In addition, embodiments of the disclosure may be made brand ambivalent. For example, multiple payment devices may be stored in a portfolio, each of which is affiliated with a different transaction processing network (e.g., Visa, Mastercard, American Express, etc.) and/or issuer. Data associated with the payment devices (e.g., rewards programs) may be retrieved from a relevant issuer and stored for each of those payment devices, allowing users to maximize incentives across different payment device providers. Additionally, in embodiments in which the disclosure depicts an image of the actual payment device, users are quickly able to identify payment accounts to be used in a transaction.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. For example, although the described embodiments mention the use of tokens for purchase transactions, tokens can also be used to access data or other services. For example, multiple people may have tickets or other access credentials used to gain access to a location or service (e.g., a train ride or concert). In this example, the tickets for the multiple people may be aggregated under a single master token.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
maintaining, by a server device, a portfolio of payment devices, each payment device in the portfolio of payment devices being associated with account information;
identifying, by the server device, a plurality of content available to a user associated with the portfolio of payment devices;
assigning, by the server device based on information associated with the plurality of content and account information for each payment device in the portfolio of payment devices, at least one appropriate content of the plurality of content to be associated with a payment device of the portfolio of payment devices, the appropriate content calculated to result in a transaction that would not have otherwise occurred; and
providing, by the server device, the at least one appropriate content to a mobile device associated with the user associated with the portfolio of payment devices.

2. The method of claim 1, wherein the method further comprises determining a mapping of content to payment devices that maximizes transactions for the portfolio of payment devices, wherein the mapping of content to payment devices is a mapping of content associated with transaction types that are frequently conducted to payment devices that are infrequently used, and a mapping of content associated with transaction types that are infrequently conducted to payment devices that are frequently used.

3. The method of claim 1, wherein the appropriate content is assigned to the payment device of the portfolio of payment devices upon determining that a latest transaction for the payment device is before a date threshold.

4. The method of claim 3, wherein the method is performed without human intervention.

5. The method of claim 1, wherein the appropriate content is determined based on a benefit associated with providing the content offsetting a cost associated with providing the content.

6. The method of claim 1, wherein the appropriate content comprises at least an incentive and one or more conditions to be met by the user in order to obtain the incentive.

7. The method of claim 6, wherein the server device is configured to monitor transactions conducted using the payment device of the portfolio of payment devices and to detect when the one or more conditions have been met.

8. The method of claim 7, wherein the server device is operated by a transaction processing network.

9. A system comprising:
a processor; and
a memory including instructions that, when executed with the processor, cause the system to, at least:
receive a request to view content associated with a portfolio of payment devices;
identify a plurality of content available to a user associated with the portfolio of payment devices;
assign, based on information associated with the plurality of content and account information for each payment device in the portfolio of payment devices, each of the content of the plurality of content to a payment device of the portfolio of payment devices, the content assigned to the payment device such that it is calculated to result in a transaction that would not have otherwise occurred; and
provide the portfolio of payment devices and the assignment of content to a mobile device associated with the user.

10. The system of claim 9, wherein the request to view content is received via a mobile application installed on the mobile device.

11. The system of claim 9, wherein the request to view content is received via a browser application.

12. The system of claim 9, wherein the instructions further cause the system to generate the portfolio of payment devices based on an identifier included in the request to view content.

13. The system of claim 12, wherein generating the portfolio of payment devices comprises:
transmitting the identifier to a number of authorization entities; and
associating each of the payment devices included in responses received from the number of authorization entities with an account associated with the user.

14. The system of claim 12, wherein generating the portfolio of payment devices comprises:
receiving a list of payment devices from the mobile device; and
associating each of the payment devices in the list of payment devices with an account associated with the user.

15. The system of claim 14, wherein the list of payment devices includes at least one token application installed on the mobile device.

16. A mobile device comprising:
a display;
a processor; and
a memory including instructions that, when executed with the processor, cause the mobile device to, at least:
receive, from a user of the mobile device, a request to provide content, the request including at least an identifier associated with the user;
transmit, to a mobile application server, the identifier;
receive, from the mobile application server, a list comprising a number of payment devices and a plurality of content, each of the plurality of content assigned to a payment device of the number of payment devices;
present the list on the display, such that the content of the plurality of content assigned to each payment device is displayed alongside the payment device; and
upon receiving a selection of a payment device of the number of payment devices, enabling the user to complete a transaction using the selected payment device.

17. The mobile device of claim 16, wherein each of the plurality of content is associated with one or more conditions.

18. The mobile device of claim 17, wherein the one or more conditions are also displayed along with its associated content of the plurality of content.
